(19) United States
(12) Patent Application Publication
(10) Pub. No.: US 2015/0262552 A1
(43) Pub. Date: Sep. 17, 2015

(54) DISPLAY DEVICE AND IMAGE DISPLAY METHOD

(71) Applicant: Naoki ITAKURA, Minato-ku, Tokyo (JP)

(72) Inventor: Naoki Itakura, Tokyo (JP)

(73) Assignee: NEC Display Solutions, Ltd., Tokyo (JP)

(21) Appl. No.: 14/436,112

(22) PCT Filed: Oct. 18, 2012
(86) PCT No.: PCT/JP2012/076910

§ 371 Date: Apr. 16, 2015

(51) Int. Cl. G09G 5/14; G09G 5/02

(52) U.S. Cl. CPC G09G 5/14; G09G 5/02; G09G 2340/12

(57) ABSTRACT

In a display device, a signal level detection circuit detects RGB signal levels for each pixel from an image signal, and then a control circuit detects an area using a gray scale of a single color based on RGB signal levels for each pixel. A first color conversion circuit carries out an image correction on an image signal while a second color conversion circuit carries out another image correction-on an image signal. An H/V position control circuit extracts an image signal of an area detected by the control circuit from an image signal subjected to the image correction of the second color conversion circuit. An image superposition circuit superposes the image signal extracted by the H/V position control circuit with the image signal subjected to the image correction of the first color conversion circuit, thus displaying the superposed image signal on a display.

### TECHNICAL FIELD

The present invention relates to a display device and an image display method.

### BACKGROUND ART

Medical images such as X-rays have been rendered with achromatic colors such as white and black or with a single chromatic color using a gray scale. Display characteristics relative to input gradation of medical images on displays are defined using DICOM (Digital Imaging and Communication in Medicine). DICOM differs from IT (Information Technology) image characteristics in that it outputs signals in accordance with applications of Picture Archiving and Communication System (PACS). Displays may require accurate gradation-luminance characteristics; hence, it is necessary to arrange an exclusive display already adjusted in details. Recently, trends for adopting applications assisting diagnosis by coloring the gray scale of a single chromatic color or trends for carrying out diagnosis with reference to lists of external injuries taken with digital cameras, other than images of medical devices, have been increasing. To concurrently handle images having different characteristics, it is necessary to use a plurality of displays for different purposes so as to accurately demonstrate display characteristics in such a way that PACS applications are carried out using a color display while sending signals of medical images to a monochrome display having different display characteristics.

Patent Literature Document 1 discloses that image signals are divided into a plurality of areas based on marker signals embedded in control signals or image signals, wherein different image processes such as an outline correction, a luminance correction, a gamma correction, and a color correction will be carried out on each area.

### CITATION LIST

### Patent Literature Document

Patent Literature Document 1: Japanese Patent Application Publication No. H11-190987

### SUMMARY OF INVENTION

### Technical Problem

The foregoing configuration using two displays separately for operating applications and for displaying medical images may raise a problem concerning degradation of visibility since each user needs to largely move their viewpoint in order to handle a plurality of displays having different display characteristics.

Owing to recent trends for enlarging screens or enhancing high resolutions of screens, a single display rendering different display characteristics has been developed. This display may improve visibility. However, a display with the entire screen configured to accurately render monochromatic display characteristics may degrade operability of applications while a display with the entire screen configured to render color display characteristics may not accurately demonstrate display characteristics of medical images. Additionally, it is troublesome for each user to specify an area displaying medical images separately of other areas rendering different display characteristics.

To resolve troublesomeness, it is easy for the skilled person in the art to invent an area specifying function for medical images in the PACS-application part. This technique needs to transmit an area specifying signal separately of an image signal. However, this technique may raise another problem concerning poor flexibility since it is necessary to coordinate a host PC (personal computer), an application, and a display together.

As described above, when an application image and a medical image are concurrently displayed on screen, it is necessary to install a display for operating an application separately of another display for displaying a medical image, or it is necessary to use a single display which loads the position of a medical image on screen by means of a communication means irrespective of an image signal. In either case, it is necessary to combine an application and a display, or it is necessary to interpose a communication tool between them; this requires plenty of restrictions. The technology of Patent Literature Document 1 needs to specify an area by use of a control signal or a marker signal; hence, it may not solve the above problems.

The present invention is created in consideration of the foregoing circumstances, that is, the present invention provides a display device, which is able to solely display images including areas having different display characteristics, and an image display method.

### Solution to Problem

[1] A first aspect of the present invention is directed to a display device including a display configured to display an image; a signal level detection part configured to detect signal levels of primary colors for each pixel from an image signal; a control part configured to detect an area using a single-color gray scale based on the signal levels of primary colors for each pixel detected by the signal level detection part; a first image correction part configured to carry out an image correction on the image signal; a second image correction part configured to carry out an image correction, which is different from the image correction of the first image correction part, on the image signal; an extraction part configured to extract an image signal of the area detected by the control part from the image signal corrected by the second image correction part; and an image superposition part configured to superpose the image signal extracted by the extraction part with the image signal corrected by the first image correction part, thus displaying the superposed image signal on the display.

[2] A second aspect of the present invention is directed to an image display method executed with a display device including a signal level detection process configured to detect signal levels of primary colors for each pixel from an image signal; a detection process configured to detect an area using a single-color gray scale based on the signal levels of primary colors for each pixel detected in the signal level detection process; a first image correction process configured to carry out an image correction on the image signal; a second image correction process configured to carry out an image correction, which is different from the image correction of the first image correction process, on the image signal; an extraction process configured to detect an image signal of the area detected in the detection process from the image signal corrected in the second image correction process; and an image superposition process configured to superpose the image signal extracted by the extraction part with the image signal corrected in the first image correction process, thus displaying the superposed image signal.

### Advantageous Effects of Invention

According to the present invention, it is possible for a single display device to display images including areas of different display characteristics without the need of specifying areas with each user or each application.

### BRIEF DESCRIPTION OF DRAWINGS

FIG. 1 is a block diagram showing the configuration of a display device according to the first embodiment of the present invention.

FIG. 2 is a flowchart showing a process of the display device according to the first embodiment.

FIG. 3 is a schematic illustration showing an example of determining a monochromatic area with a control circuit according to the first embodiment.

FIG. 4 is a block diagram showing the configuration of a display device according to the second embodiment.

FIG. 5 is a flowchart showing a process of the display device according to the second embodiment.

### DESCRIPTION OF EMBODIMENTS

Hereinafter, the embodiments of the present invention will be described with reference to the drawings.

Medical images such as X-rays are rendered in monochrome (i.e. white-and-black or shading of a specific color; hereinafter, referred to as “monochrome”), wherein display characteristics of medical images relative to input gradation on a display are defined using DICOM (Digital Imaging and Communication in Medicine). However, medical images have various lengthwise-crosswise sizes, and therefore monochrome displaying application images used to manipulate medical images may be hardly processed due to loss of visibility and operability. For this reason, the present embodiment is directed to a display device which is able to carry a plurality of operations concerning color conversion and image conversion on a single input signal, wherein the present embodiment is designed to detect a monochromatic area included in a color image signal, carry out a special image correction for a monochromatic image on the detected area alone, and then superpose the corrected signal with the original signal. Thus, it is possible to achieve an accurate gray scale while maintaining the visibility and operability of applications.

### First Embodiment

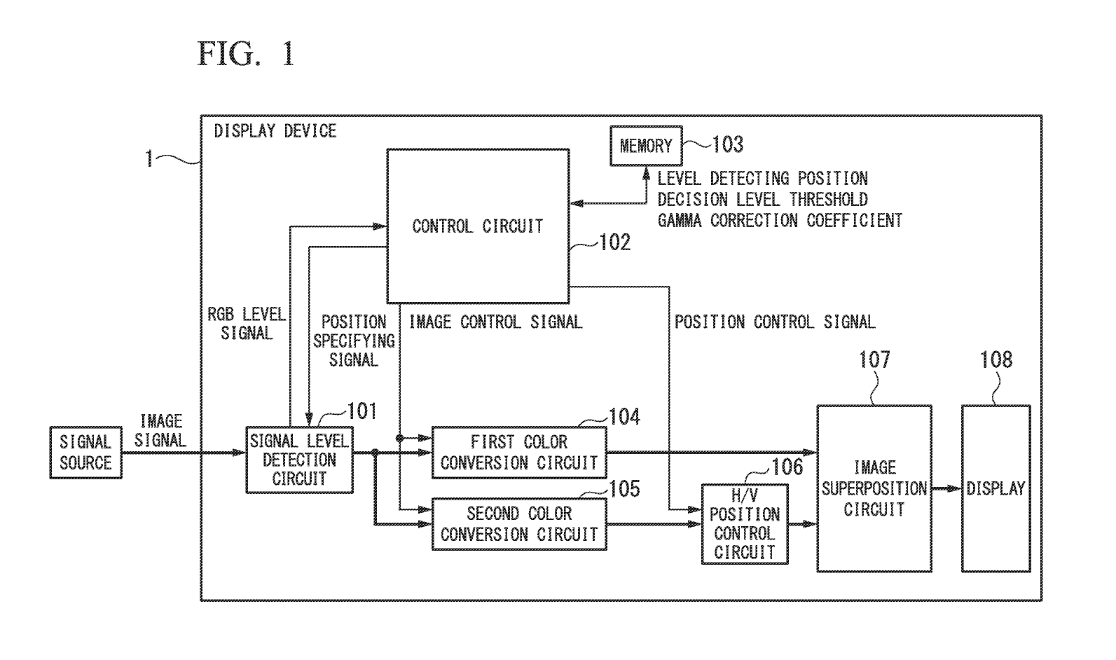

FIG. 1 is a block diagram showing the configuration of a display device 1 according to the first embodiment of the present invention. As shown in FIG. 1, the display device 1 includes a signal level detection circuit 101 (or a signal level detection part), a control circuit 102 (or a control part), a memory device 103, a first color conversion circuit 104 (or a first image correction part), a second color conversion circuit 105 (or a second image correction part), an H/V (Horizontal/Vertical) position control circuit 106 (or an extraction part), an image superposition circuit 107 (or an image superposition part), and a display 108.

The signal level detection circuit 101 detects a signal level representing RGB (Red, Green, Blue) of an image signal from a signal source so as to output the detected signal level as an RGB level signal to the control circuit 102. To further obtain different color conversion outputs, the signal level detection circuit 101 outputs an image signal input from the signal source to the first color conversion circuit 104 and the second color conversion circuit 105.

The control circuit 102 is an MPU (Micro-Processing Unit) which is able to access the memory device 103. The control circuit 102 outputs a position specifying signal which instructs the signal level detection circuit 101 to measure signal levels. The control circuit 102 detects a monochromatic area based on signal levels of RGB colors indicated by an RGB level signal which is output from the signal level detection circuit 101 in response to a position specifying signal. Additionally, the control circuit 102 outputs to the first color conversion circuit 104 an image control signal for instructing an image correction applied to the entire image (or a color image) while outputting to the second color conversion circuit 105 an image control signal for instructing an image correction applied to a monochromatic image. Moreover, the control circuit 102 outputs a position control signal, representing the position of the detected monochromatic area, to the H/V position control circuit 106.

The memory device 103 stores a decision level threshold, a gamma correction coefficient applied to the entire image (or a color image), and a gamma correction coefficient applied to a monochromatic image. The decision level threshold represents chrominance used to determine whether or not two images have the same color.

The first color conversion circuit 104 carries out an image correction, according to an image control signal from the control circuit 102, on an image signal from the signal level detection circuit 101, thus outputting the corrected image signal to the image superposition circuit 107. The second color conversion circuit 105 carries out an image correction, according to an image control signal from the control circuit 102, on an image signal from the signal level detection circuit 101, thus outputting the corrected image signal to the H/V position control circuit 106.

The H/V position control circuit 106 extracts a monochromatic-area image signal from an image signal of the second conversion circuit 105 in accordance with the position indicated by a position control signal of the control circuit 102, thus outputting the monochromatic-area image signal to the image superposition circuit 107. Thus, part of the input image is solely input to the image superposition circuit 107 via the H/V position control circuit 106.

The image superposition circuit 107 superposes an image signal of the first color conversion circuit 104 with an image signal output from the H/V position circuit 106, thus outputting the superposed image signal to the display 108. The display 108 is a display panel such as LCD (Liquid Crystal Display), which display image signals superposed by the image superposition circuit 107.

Next, the operation of the display device 1 will be described. In this connection, xn (where n is a positive integer equal to or less than N) denotes a pixel position of an image signal in a horizontal direction while ym (where m is a positive integer equal to or less than M) denotes a pixel position of an image signal in a vertical direction. Additionally, Rnm denotes a red signal level; Bnm denotes a blue signal level; and Gnm denotes a green signal level at coordinates (xn, ym).

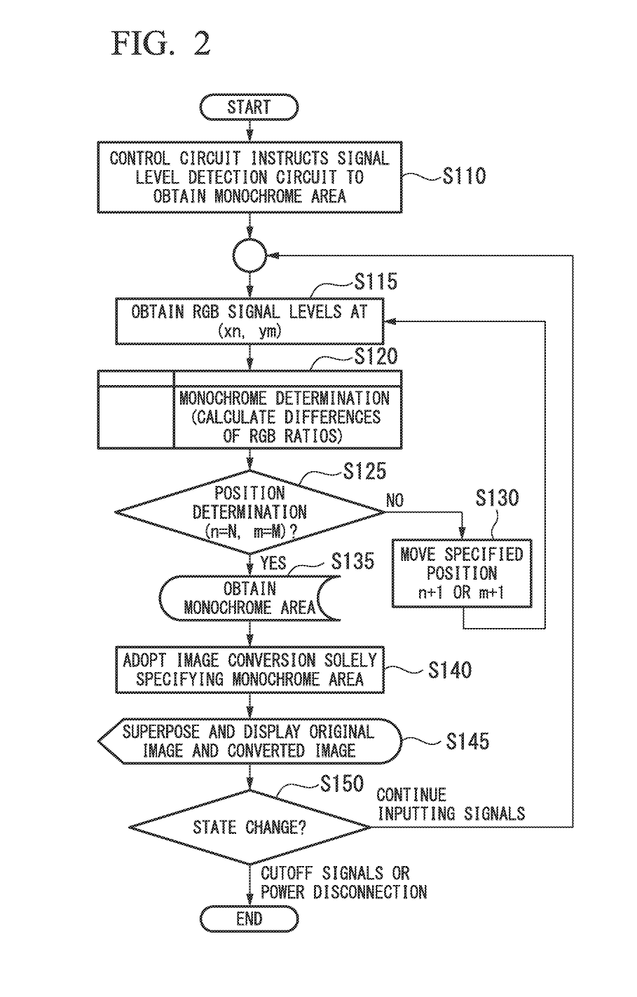

FIG. 2 is a flowchart showing a process of the display device 1.

First, each user turns on the power on the display device 1. After a power-on event, the signal source supplies an image signal to the signal level detection circuit 101, and therefore the control circuit 102 instructs the signal level detection circuit 101 to obtain the range of a monochromatic area (step S110).

The control circuit 102 firstly determines the sampling point (the measurement position) at coordinates (x1, y1). The control circuit 102 outputs a position specifying signal, i.e. an instruction to obtain signal levels at the determined sampling point, to the signal level detection circuit 101. The signal level detection circuit 101 detects signal levels of RGB colors at the sampling point specified by the position specifying signal, thus outputting an RGB level signal describing the detected signal levels to the control circuit 102 (step S115).

The control circuit 102 obtains a red signal level R11, a green signal level G11, and a blue signal level B11 from RGB signal levels. The control circuit 102 calculates signal level ratios [R11/(R11+G11+B11), G11/(R11+G11+G11), B11/(R11+G11+B11)] relative to the entire coloring of RGB colors (step S120). The control circuit 102 does not determine monochrome since it fails to detect signal levels at adjacent sampling points, but it carries out step S125.

The control circuit 102 determines that the coordinates (x1, y1) of the current sampling point does not match the maximum coordinates (xN, yM) (step SP125: NO), thus moving the coordinates of the sampling point to (x2, y2) (step S130).

The control circuit 102 outputs to the signal level detection circuit 101 a position specifying signal instructing the signal level detection circuit 101 to detect signal levels at the moved sampling point. The signal level detection circuit 101 detects signal levels of RGB colors at the sampling point specified by a position specifying signal, thus outputting an RGB level signal, describing the detected signal levels, to the control circuit 102 (step S115).

The control circuit 102 obtains a red signal level R21, a green signal level G21, and a blue signal level B21 from RGB signal levels. The control circuit 102 calculates signal level ratios [R21/(R21+G21+B21), G21(R21+G21+B21), B21/(R21+G21+B21)] relative to the entire coloring o RGB colors.

Additionally, the control circuit 102 calculates differences of ratios, [R21/(R21+G21+B21)−R11/(R11+G11+B11), G21/(R21+B21+B21)−G11/(R11+G11+B11), B21/(R21+G21+B21)−B11/(R11+G11+B11)], relative to the entire coloring of RGB colors with respect to adjacent sampling points at coordinates (x1, y1) and (x2, y1). The control circuit 102 determines that the “identical color” is applied to the sampling points at coordinates (x1, y1) and (x2, y1) when differences of ratios relative to the entire coloring of the calculated colors are zeros, or the control circuit 102 determines that the “non-identical color” is applied to them when differences of ratios exceed those ranges. The control circuit 102 temporarily stores the determination results in connection with the coordinates of sampling points (step S120).

The control circuit 102 determines that the coordinates (xn, ym) of the current sampling point do not match the maximum coordinates (xN, yM) (step S125: NO), so as to move the coordinates of the sampling point (step S130), thus repeating the foregoing processes beginning with step S115. For example, the control circuit 102 determines a new sampling point at coordinates (x(i+n), ym) when i<N but determines a new sampling point at coordinates (x1, y(m+1)) when i=N.

The control circuit 102 and the signal level detection circuit 101 repeats a series of operations from step S115 to step S130 until the sampling point reaches the maximum coordinates (xN, yM).

When the coordinates of a sampling point reaches the maximum coordinates (step S125: YES), the control circuit 102 reads the coordinates of sampling points, which are stored in the memory device 103 as the identical color, so as to detect the maximum rectangular area, including those coordinates, as a monochrome area (step S135).

The control circuit 102 reads a gamma correction coefficient, applied to the entire image, from the memory device 103 so as to instruct the first color conversion circuit 104 of the read gamma correction coefficient with an image control signal. Additionally, the control circuit 102 reads a gamma correction coefficient, applied to a monochromatic image, from the memory device 103, so as to instruct the second color conversion circuit 105 of the read gamma correction coefficient. The control circuit 102 outputs a position control signal, indicating the position of the monochromatic area detected in step S135, to the H/V position control circuit 106.

The signal level detection circuit 101 outputs an image signal to the first color conversion circuit 104 and the second color conversion circuit 105. The first color conversion circuit 104 corrects the color of an image, indicated by the input image signal from the signal level detection circuit 101, with the gamma correction coefficient for use in the entire image specified by an image control signal, thus outputting the corrected image signal to the image superposition circuit 107. The second color conversion circuit 105 corrects the color of an image, indicated by the input image signal from the signal level detection circuit 101, with a gamma correction coefficient for use in the monochromatic image specified by an image control signal, thus outputting the corrected image signal to the H/V position control circuit 106 (step S140).

The H/V position control circuit 106 extracts a monochromatic-area image signal from the image signal of the second color conversion circuit 105 in accordance with the position indicated by the position control signal of the control circuit 102, thus outputting the monochromatic-area image signal to the image superposition circuit 107. The image superposition circuit 107 superposes the image signal of the first color conversion circuit 104 with the monochromatic-area image signal of the H/V position control circuit 106, thus outputting the superposed image signal to the display 108. The display 108 displays the image superposed by the image superposition circuit 107 (step S145).

When image signals are continuously input from the signal source (step S150: continue inputting signals), the control circuit 102 sets an initial value of a sampling point at coordinates (x1, y1) so as to repeat the foregoing operations beginning with step S115. When image signals input from the signal source are cut off, or when power is turned off on the display device 1 (step S150: cutoff of signals or power disconnection), the control circuit 102 exits the process.

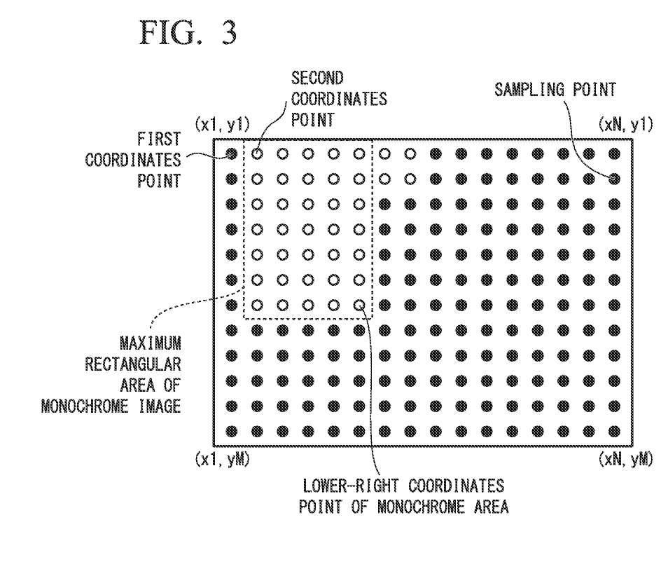

FIG. 3 is a schematic illustration showing an example of determining a monochromatic area with the control circuit 102. In this figure, black circles denote sampling points which are determined to be identical to adjacent sampling points in coloring, while white circles denote sampling points which are determined not to be identical to adjacent sampling points in coloring.

As described above, the control circuit 102 of the display device 1 of the present embodiment determines a first point of coordinates representing a sampling point at which RGB signal levels will be measured on screen, wherein it sequentially compares RGB signal levels at the first point of coordinates with RGB signal levels at second points of coordinates representing sampling points neighboring the first point of coordinates, thus detecting an area of a monochromatic image.

To detect a rectangular monochromatic area, for example, the control circuit 102 initially determines a first point of coordinates at left-upper coordinates (x1, y1) and then determines a second point of coordinates, positioned in the neighborhood of the first point of coordinates, e.g. coordinates (x2, y1) on the right of the first point of coordinates. The control circuit 102 calculates differences of ratios of RGB colors relative to the entire coloring at neighboring sampling points. When calculation results fall within the predetermined range, i.e. the decision level threshold, the control circuit 102 determines that the data of the second point of coordinates have the “identical color” with the data of the second point coordinates. In contrast, when calculation results exceed the threshold, the control circuit 102 determines “non-identical color”. Thus, the control circuit 102 temporarily stores the determination results in the memory device 103.

The control circuit 102 repeats the above operation with respect to the entire area on screen. As shown in FIG. 3, the control circuit 102 detects a monochromatic area corresponding to the maximum rectangular area including sampling points which are determined to be the “same color”. The control circuit 102 outputs a control signal, indicating the position of a monochromatic area, to the H/V position control circuit 106 so as to display a specially-processed image in the determined area. Thus, the image superposition circuit 107 superposes a monochrome, which is subjected to a monochromatic image correction by the second color conversion circuit 105, with an image, which is subjected to a color image correction by the first color conversion circuit 104, thus displaying the superposed image on screen.

According to the present embodiment, the display device 1 is designed to automatically detect a monochromatic area; hence, it is possible to display gamma characteristics, which are important for displaying X-ray images, in an appropriate condition without each user specifying an exclusive area. This is because the display device 1 is able to accurately obtain a monochromatic display area by detecting pixels, having a constant ratio for each color, in accordance with the level detection process and the process of detecting the chrominance range without using color information, thus changing gamma correction coefficients with predetermines ones solely for use in the monochromatic display area. In the present embodiment, the display device 1 is designed to normally obtain RGB signal levels with respect to the input image signal during the power-on period. Therefore, the display device 1 is able to automatically track and move the positions subjected to the monochromatic-image color conversion irrespective of changes of positions or sizes of monochromatic images unless the input state of video signals is not changed.

### Second Embodiment

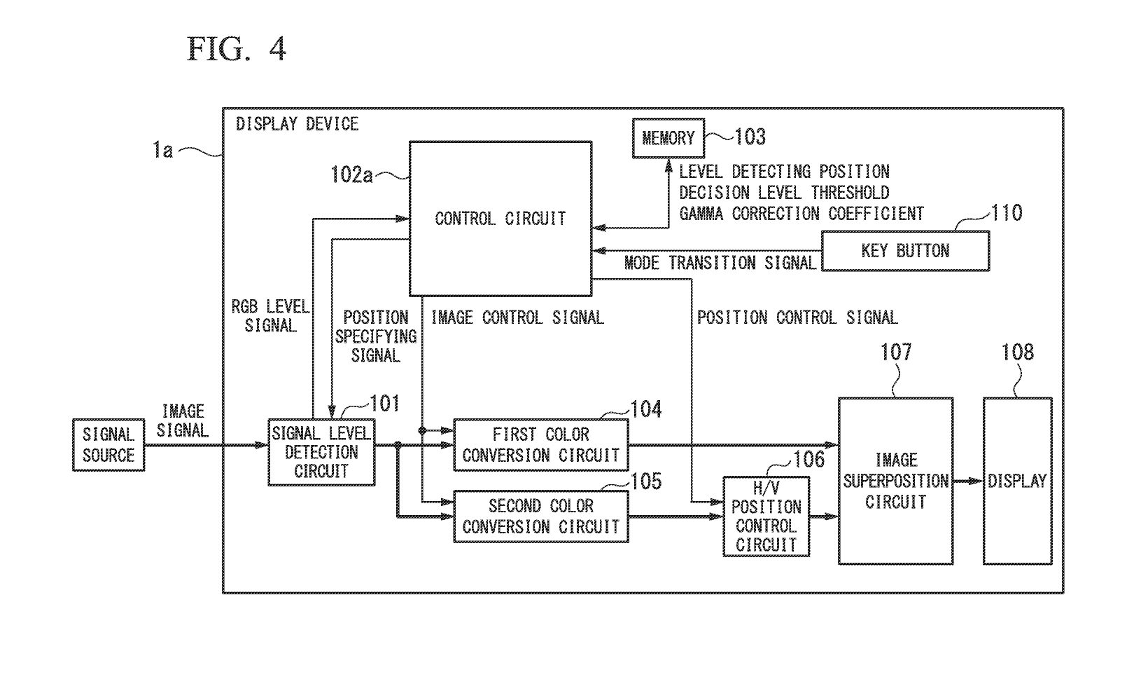

FIG. 4 is a block diagram showing the configuration of a display device 1a according to the second embodiment of the present invention. The display device 1a of FIG. 4 differs from the display device 1 of the first embodiment shown in FIG. 1 by further arranging a key button 110 and by changing the control circuit 102 with a control circuit 102a.

The key button 110 inputs a transition instruction or an exit instruction concerning a monochrome detection mode by each user of the display device, thus outputting a mode transition signal to the control circuit 102. The control circuit 102a carries out the same process as the control circuit 102 of the first embodiment when the key button 110 is operated to input a mode transition signal indicating a transition to a monochrome detection mode.

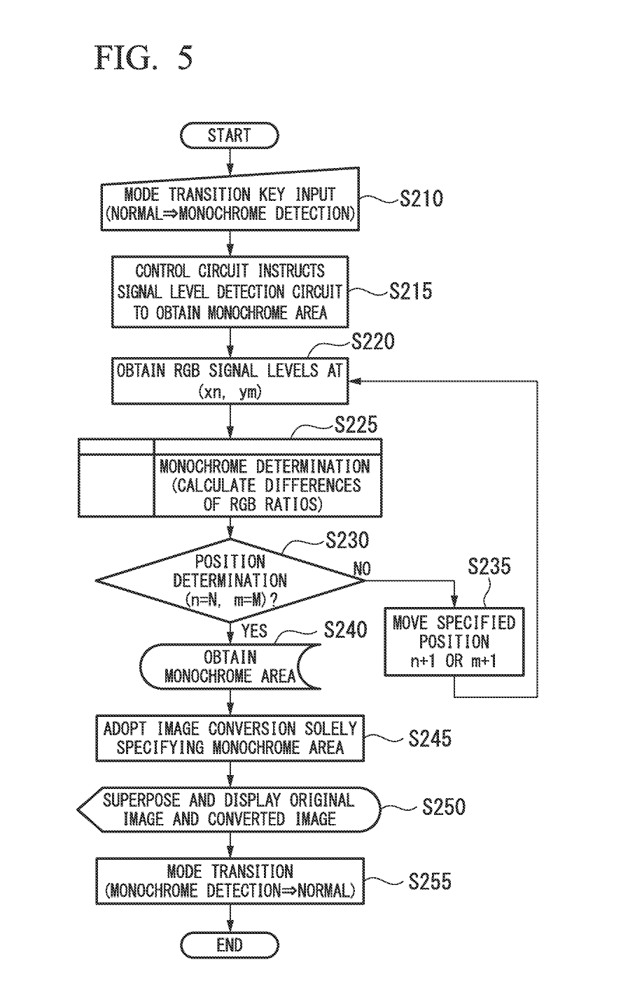

FIG. 5 is a flowchart showing a process of the display device 1a.

First, each user turns on the power on the display device 1a. After the power-on event, the display device 1a displays video on screen in a normal mode when the signal level detection circuit 101 inputs an image signal from the signal source. In the normal mode, the signal level detection circuit 101 outputs an image signal to the first color conversion circuit 104, and then the first color conversion circuit 104 corrects the color of an image indicated by the image signal by use of a gamma correction coefficient, thus outputting the corrected image signal to the image superposition circuit 107. The image superposition circuit 107 directly displays the image signal input from the first color conversion circuit 104 on the display 108.

Each user operates the key button 110 to input a transition instruction towards a monochrome detection mode. The key button 110 outputs a mode transition signal, indicating a transition to a monochrome detection mode, to the control circuit 102a. Upon receiving a mode transition signal, the control circuit 102a outputs an instruction to obtain signal levels, used to obtain a white-and-black image area, to the signal level detection circuit 101 (step S210). The display device 1a carries out the same process as steps S115 to S145 of FIG. 2 (steps S215 to S250). Herein, the control circuit 102a carries out the process of the control circuit 102 of the first embodiment. After an exit of step S250, the control circuit 102a restores the display device 1a in the normal mode (step S255).

As described above, in the present embodiment, each user of the display device 1a turns on the power, inputs an image signal, and then operates the key button 110 to output a mode transition signal, used to determine a monochromatic image, to the control circuit 102a. Correspondingly, the control circuit 102a outputs an instruction of obtaining the area of a monochromatic area to the signal level detection circuit 101. After outputting the instruction, the display device 1a carries out the same operation as the first embodiment so as to calculate differences of ratios of RGB colors to the entire coloring, to carry out a process of determining whether or not monochrome is applied to coordinates from (x1, y1) to (xN, yM), and to superpose the converted image subjected to a monochromatic image correction with the original image, thus displaying the superposed image on screen.

The present embodiment does not include a process of monitoring and determining a change of state in inputting signals, which is used in the first embodiment; hence, after the determination of a monochromatic image area, the display device 1a reverts to the normal mode from the monochrome detection mode. Therefore, the present embodiment is unable to track changes of positions or sizes of monochromatic images, but it is possible to reduce the operation load of the control circuit 102a since a series of processes in obtaining signal levels, calculating and determining monochrome, and determining positions can be completed by repeating processes by the number of sampling points, i.e. N×M times.

### Third Embodiment

When a monochromatic image is an achromatic, white-and-black, color image which is rendered in a gray scale of a single color, i.e. black, on white, it is possible to determine a monochromatic area via the following process. That is, in step S120 of the first embodiment shown in FIG. 2, the control circuit 102 temporarily stores a white-and-black pixel, corresponding to a sampling point of coordinates (xn, ym) having signal levels Rnm=Gnm=Bnm, in the memory device 103. In step S130, the control circuit 102 reads coordinates, which are stored as white-and-black pixels in the memory device 102, so as to detect a white-and-black area (a monochromatic area) representing the maximum rectangular area including the read coordinates.

In this connection, it is possible for the second embodiment to employ the foregoing process as the process of the control circuit 102a concerning steps S225 and S240 in FIG. 5, thus determining a white-and-black area.

Heretofore, the present invention has been described with reference to the foregoing embodiments, wherein the control circuit 102 of FIG. 1 and the control circuit 102a of FIG. 2 may load programs, configured to carry out the foregoing processes, from a memory device of an MPU so as to execute programs, thus carrying out the foregoing processes.

The above programs may be stored in a storage device of a computer system and then transmitted to another computer system via transmission media or via transmitting waves in transmission media. Herein, “transmission media” used to transmit programs refer to any media having information transmitting functions, e.g. networks (communication networks) such as the Internet and communication lines such as telephone lines. The above programs may be drafted to carry out part of the foregoing functions. Additionally, the above programs may be drafted as differential files (or differential programs) which are combined with pre-installed programs of computer systems so as to carry out the foregoing functions.

Part or entirety of the foregoing embodiments can be described in the following supplementary notes; but this is not a restriction.

(Supplementary Note 1)

A display device is characterized by including a display configured to display an image; a signal level detection part configured to detect signal levels of primary colors for each pixel from an image signal; a control part configured to detect an area using a single-color gray scale based on the signal levels of primary colors for each pixel detected by the signal level detection part; a first image correction part configured to carry out an image correction on the image signal; a second image correction part configured to carry out an image correction, which is different from the image correction of the first image correction part, on the image signal; an extraction part configured to extract an image signal of the area detected by the control part from the image signal corrected by the second image correction part; and an image superposition part configured to superpose the image signal extracted by the extraction part with the image signal corrected by the first image correction part, thus displaying the superposed image signal on the display.

(Supplementary Note 2)

The display device described in Supplementary Note 1 is characterized in that, when differences of ratios of the signal levels of primary colors to all primary colors between a pixel of the image signal and an adjacent pixel adjacent to the pixel fall within a predetermined range, the control part determines that the pixel and the adjacent pixel have an identical color, thus detecting a rectangular area, including the pixels which are determined to have the identical color, as the area using the single-color gray scale.

(Supplementary Note 3)

The display device described in Supplementary Note 1 is characterized in that the control part detects a pixel having the same signal level with respect to all primary colors as a pixel using the single-color gray scale, thus detecting a rectangular area including the detected pixel as the area using the single-color gray scale.

(Supplementary Note 4)

The display device described in any one of Supplementary Note 1 to Supplementary Note 3 is characterized in that the control part detects the area using the single-color gray scale when inputting the image signal or when inputting a transition instruction to a detection mode.

(Supplementary Note 5)

An image display method executed with a display device is characterized by including a signal level detection process configured to detect signal levels of primary colors for each pixel from an image signal; a detection process configured to detect an area using a single-color gray scale based on the signal levels of primary colors for each pixel detected in the signal level detection process; a first image correction process configured to carry out an image correction on the image signal; a second image correction process configured to carry out an image correction, which is different from the image correction of the first image correction process, on the image signal; an extraction process configured to detect an image signal of the area detected in the detection process from the image signal corrected in the second image correction process; and an image superposition process configured to superpose the image signal extracted by the extraction part with the image signal corrected in the first image correction process, thus displaying the superposed image signal.

### REFERENCE SIGNS LIST

1, 1a . . . display device
101 . . . signal level detection circuit
102, 102a . . . control circuit
103 . . . memory device
104 . . . first color conversion circuit
105 . . . second color conversion circuit
106 . . . H/V position control circuit
107 . . . image superposition circuit
108 . . . display
110 . . . key button

1. A display device comprising:
a display configured to display an image;
a signal level detection part configured to detect signal levels of primary colors for each pixel from an image signal;
a control part configured to detect an area using a single-color gray scale based on the signal levels of primary colors for each pixel detected by the signal level detection part;
a first image correction part configured to carry out an image correction on the image signal;
a second image correction part configured to carry out an image correction, which is different from the image correction of the first image correction part, on the image signal;
an extraction part configured to extract an image signal of the area detected by the control part from the image signal corrected by the second image correction part; and
an image superposition part configured to superpose the image signal extracted by the extraction part with the image signal corrected by the first image correction part, thus displaying a superposed image signal on the display.

2. The display device according to claim 1, wherein when differences of ratios of the signal levels of primary colors to all primary colors between a pixel of the image signal and an adjacent pixel adjacent to the pixel fall within a predetermined range, the control part determines that the pixel and the adjacent pixel have an identical color, thus detecting a rectangular area, including the pixels which are determined to have the identical color, as the area using the single-color gray scale.

3. The display device according to claim 1, wherein the control part detects a pixel having a same signal level with respect to all primary colors as a pixel using the single-color gray scale, thus detecting a rectangular area including the detected pixel as the area using the single-color gray scale.

4. The display device according to claim 1, wherein the control part detects the area using the single-color gray scale when inputting the image signal or when inputting a transition instruction to a detection mode.

5. An image display method executed with a display device, comprising:
a signal level detection process configured to detect signal levels of primary colors for each pixel from an image signal;
a detection process configured to detect an area using a single-color gray scale based on the signal levels of primary colors for each pixel detected in the signal level detection process;
a first image correction process configured to carry out an image correction on the image signal;
a second image correction process configured to carry out an image correction, which is different from the image correction of the first image correction process, on the image signal;
an extraction process configured to detect an image signal of the area detected in the detection process from the image signal corrected in the second image correction process; and
an image superposition process configured to superpose the image signal extracted by the extraction part with the image signal corrected in the first image correction process, thus displaying a superposed image signal.
